(19) United States
(12) Patent Application Publication
(10) Pub. No.: US 2005/0232206 A1
(43) Pub. Date: Oct. 20, 2005

(54) Intelligent wireless switch (IWS) and intelligent radio coverage (IRC) for mobile applications

(75) Inventors: Sammy Ming Kit Chau, Kowloon (HK); Soung C. Liew, Hong Kong (CN); Vincent Lau, Hong Kong (CN); Piu B. Wong, Hong Kong (HK)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Hong Kong Applied Science and Technology Research Institute Co., Ltd., New Territories (HK)

(21) Appl. No.: 10/825,089

(22) Filed: Apr. 15, 2004

(51) Int. Cl. H04Q 7/24

(52) U.S. Cl. 370/338

(57) ABSTRACT

The present invention is generally related to managing wireless communications associated with a plurality of mobile devices moving in the same direction. In one embodiment, an intelligent wireless switch (IWS) is used to manage communications. The IWS includes an internal access point for managing a wireless local area network (WLAN) for a plurality of wireless devices. The IWS includes a plurality of stations for communicating with a plurality of external access points. The IWS also includes a packet switch controller for directing data between the plurality of wireless devices and the plurality of stations. By switching between the plurality of stations in response to the signal strengths of the external access points, the plurality of wireless devices are able to continuously conduct data communications without interruptions associated with reaching the limits of a coverage area of an external access point.

### TECHNICAL FIELD

The present invention is generally related to wireless communications and, more particularly, to managing wireless communications associated with a plurality of mobile devices.

### BACKGROUND OF THE INVENTION

At the present time, wireless networks are beginning to be deployed that enable public access to data communications resources. For example, many public forums (e.g., public transportation facilities, government buildings, office buildings, and the like) provide “Wi-Fi” wireless networking capabilities to enable individuals to communicate via the Internet.

The process of establishing a presence within a particular wireless network typically begins by locating an “access point.” As used herein, an access point broadly refers to any device within a respective wireless network or service area that manages wireless communications within that network or area to enable access to a larger network. An access point should not be interpreted to require any particular wireless communication protocol or standard.

The management of wireless communications usually involves providing association services, disassociation services, distribution services, and integration services. The association and disassociation services enable mobile devices to join and leave a particular wireless network or service area in an orderly manner. As used herein, association refers to a protocol or message sequence that enables a wireless device to begin communication within a network or service area managed by an access point. Distribution services manage the processing and routing of wireless frames within the network or service area. Distribution services may involve medium access control (MAC) protocols to prevent communications of identified wireless devices from interfering with each other. Integration services involve translation of wireless frames into a form that is suitable for traversal through another network (usually to enable access to the Internet) and vice versa.

An access point can typically be located by detecting a “beacon” frame from the access point or other suitable signal. A beacon frame is transmitted periodically to enable wireless devices to associate with an access point. The beacon frame enables the physical layer parameters (e.g., the operating band), capability information, and other suitable information to be determined. The beacon period (the time between the broadcast of beacon frames) can be sufficiently great to cause the amount of time required by the association process to be noticable by a user.

Reference is made to FIG. 1 to illustrate how association operations occur according to typical wireless communication protocols. Train 101 holds a number of users having wireless devices 102. Train 101 traverses through a number of wireless communication service areas. The service areas are defined by the broadcast distances of access points 103-1 and 103-2. As shown in FIG. 1, the service area defined by access point 103-1 extends to boundary 104-1 and the service area defined by access point 103-2 extends to boundary 104-2. The service areas can overlap by using different operating bands, chipping sequences, hopping sequences, and/or the like for access points 103-1 and 103-2.

When train 101 moves into the service area defined by access point 103-1, wireless devices 102 detect access point 103-1 using typical wireless protocols. Wireless devices 102 associate with access point 103-1. Wireless devices 102 may communicate data via the Internet using access point 103-1 until train 101 passes boundary 104-1. At that point, wireless devices 102 lose contact with access point 103-1. Wireless devices 102 then attempt to locate another access point. During that process, each wireless device 102 scans available channels to eventually detect access point 103-2. After detection, wireless devices 102 initiate association operations with access point 103-2. While scanning the available channels and completing the association operations, the data communication through the Internet by wireless devices 102 may be interrupted for several seconds. Accordingly, the quality of service experienced by users of wireless devices 102 can be relatively poor depending upon the number of times the association process is performed.

### BRIEF SUMMARY OF THE INVENTION

Representative embodiments are directed to systems and methods for managing wireless communications between a plurality of wireless devices that are moving in the same direction. In one representative embodiment, an intelligent wireless switch moves in the same direction as the wireless devices. The intelligent wireless switch coordinates wireless communications between the plurality of wireless devices and wireless access points. In one embodiment, the intelligent wireless switch employs a plurality of wireless stations. As used herein, a wireless station broadly refers to a wireless device that is capable of wireless communication within a network or service area using an access point. The intelligent wireless switch of a preferred embodiment also includes an internal access point. The plurality of wireless devices begin wireless communications by associating with the internal access point of the intelligent wireless switch.

The intelligent wireless switch enables substantially continuous wireless communications to occur by successively associating with exterior wireless access points through its plurality of wireless stations. Specifically, when the intelligent wireless switch first detects an access point, one of the plurality of stations associates with that access point. Data associated with the wireless devices is routed to and from the access point through the respective station.

When another access point is detected by the intelligent wireless switch, the other station associates with the second access point. Typically, this occurs when an overlap in coverage exists between the two exterior access points. At this point, the stations of the intelligent wireless switch are associated with two different access points. Data communication continues with the first access point and the connection with the second access point is maintained by use of ping packets or the like.

As the intelligent wireless switch and plurality of wireless devices continue moving, the devices eventually reach the limit of the coverage area of the first exterior access point. At that time, the intelligent wireless switch detects the reduction in received signal strength from the access point. In response thereto, the intelligent wireless switch routes data associated with the wireless devices to the second access point using the second station. Because a connection already exists with the second access point, the handoff is transparent to the plurality of wireless devices. Thus, the quality of service of data communications of the plurality of wireless devices is maintained.

In other embodiments, an intelligent radio coverage algorithm is employed to maintain wireless communications with the intelligent wireless switch. Specifically, each exterior access point is associated with a controllable directional antenna. The controllable directional antenna may comprise a plurality of discrete antenna elements. The directionality is achieved by varying the patterns of antenna elements used to communicate with the intelligent wireless switch. The selection of the antenna element patterns may occur by monitoring the signal strengths received from the intelligent wireless switch for the respective patterns.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 depicts a typical wireless communication system.

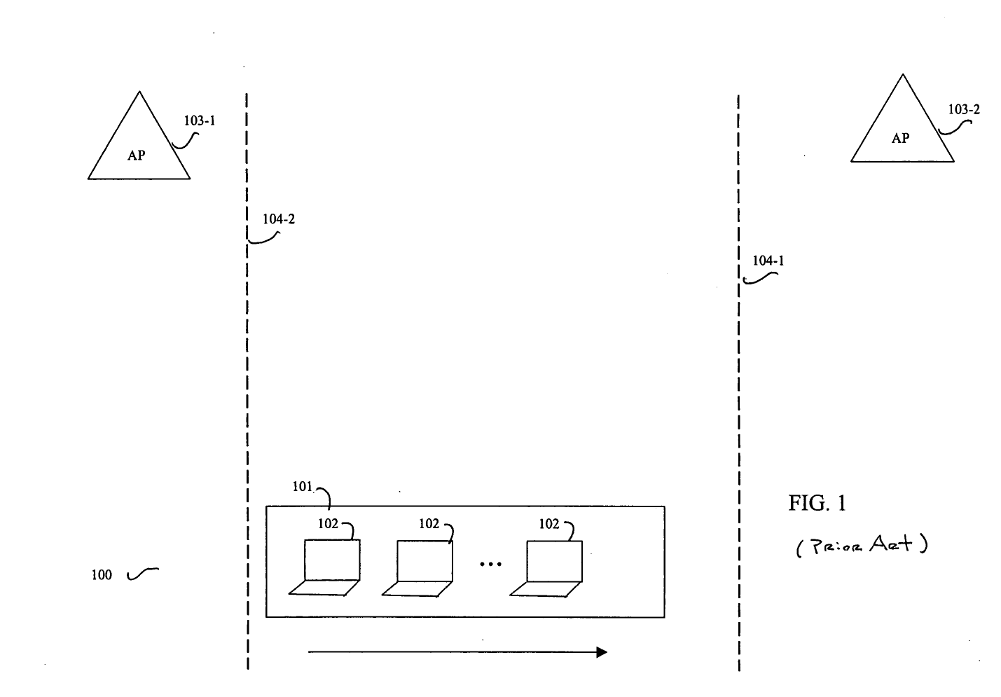

FIG. 2 depicts an intelligent wireless switch according to one representative embodiment.

FIG. 3 depicts a wireless communication system according to one representative embodiment.

FIG. 4 depicts a flowchart for managing wireless communications according to one representative embodiment.

FIG. 5 depicts another wireless communication system according to one representative embodiment.

FIG. 6 depicts a flowchart for operating a base station according to one representative embodiment.

### DETAILED DESCRIPTION OF THE INVENTION

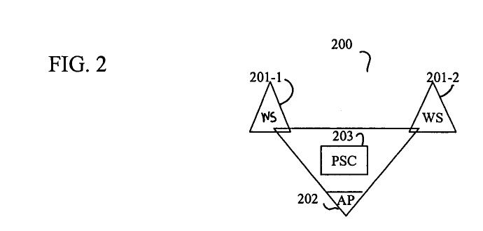

FIG. 2 depicts intelligent wireless switch 200 according to one representative embodiment. Intelligent wireless switch 200 comprises a plurality of wireless stations (shown as 201-1 and 201-2). Wireless stations 201-1 and 201-2 include suitable functionality to associate with exterior wireless access points and to communicate data to and from the access points.

Wireless switch 200 further comprises internal access point 202. Access point 202 manages a wireless local area network (WLAN) for a plurality of wireless devices. Access point 202 of a preferred embodiment performs typical access point services such as association services, disassociation services, distribution services, and integration services. The integration services of access point 202 are supported by packet switch controller 203. Packet switch controller 203 routes data between access point 202 and the “active” station of wireless stations 201-1 and 201-2. Packet switch controller 203 sets the active station by examining the signal strength received by wireless stations 201-1 and 201-2. Packet switch controller 203 may be implemented in a number of ways. For example, packet switch controller 203 could be implemented using integrated circuit functionality. Alternatively, packet switch controller 203 could be implemented using a processor and suitable software instructions.

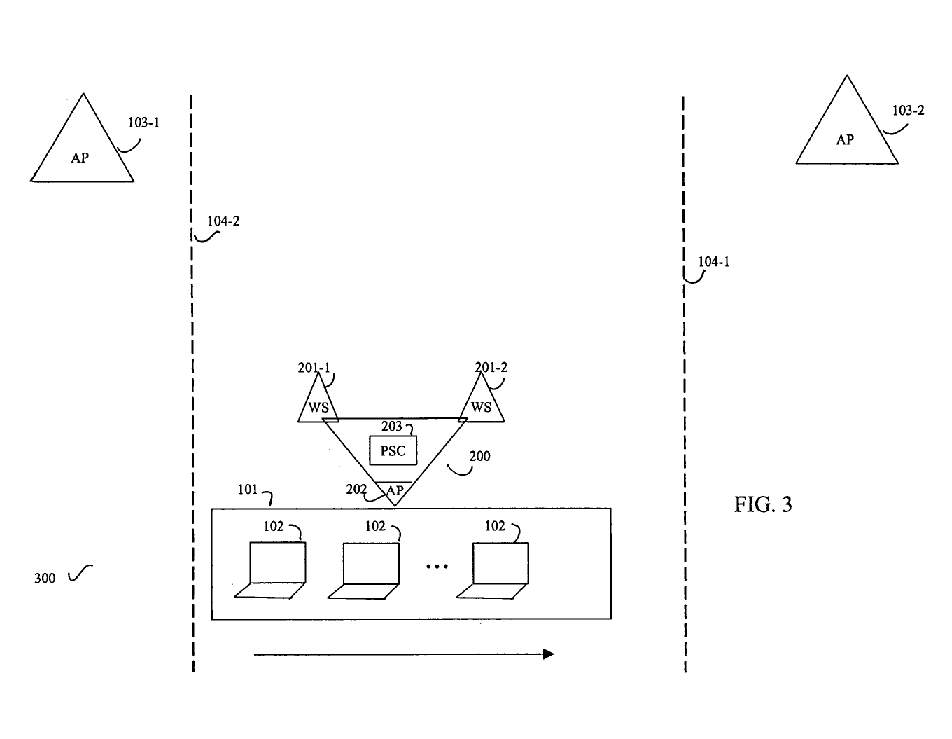

FIG. 3 depicts wireless communications system 300 that includes intelligent wireless switch 200 according to one representative embodiment. System 300 includes a plurality of access points 103-1 and 103-2. In this example, train 101 traverses through a number of wireless communication service areas and, hence, intelligent wireless switch 200 and mobile devices 102 move in the same direction. The service areas are defined by the broadcast distances of access points 103-1 and 103-2. As shown in FIG. 3, the service area defined by access point 103-1 extends to boundary 104-1 and the service area defined by access point 103-2 extends to boundary 104-2.

According to one embodiment, when train 101 first enters the coverage area of access point 103-1, station 201-1 of intelligent wireless switch 200 associates with access point 103-1. Station 201-1 is “online,” i.e., routing of data can occur through station 201-1. Also, station 201-1 becomes the “active” station. That is, data from wireless devices 102 is provided to station 201-1 and communicated to access point 103-1. Also, data from access point 103-1 is received by station 201-1 and distributed to wireless devices 102. When train 101 enters the coverage area defined by access point 103-2, station 201-2 associates with access point 103-2. Station 201-2 is then online but not active. Initially, data is not routed through station 201-1 to access point 103-2. The connection between station 201-2 and access point 103-2 can be maintained by communicating “dummy” packets through access point 103-2. For example, ping packets could be used for this purpose.

Packet switch controller 203 monitors the received signal strength associated with stations 201-1 and 201-2. The received signal strength may be filtered by the following smoothing function:
ssᵢ=ssₘₑₐₛᵤᵣₑ×α+ssᵢ₋₁×(1−α), where α is a constant, 0<α≦=1

According to a preferred embodiment, packet switch controller 203 causes station 201-1 to become inactive and station 201-2 to become active when the filtered signal strength received by station 201-1 is lower than a threshold value (threshold_{low}) and the filtered signal strength received by station 201-2 is higher than a threshold value (threshold_{high}). As shown in FIG. 3, the change in the active status of stations 201-1 and 201-2 occurs between boundaries 104-1 and 104-2.

When station 201-2 becomes the active station, subsequent packets from wireless devices 102 are communicated through station 201-2 to access point 103-2. Remaining packets from access point 103-1 are received by station 201-1 and distributed to wireless devices 102. Acknowledgement packets required for transmission control protocol (TCP) sessions or the like may be communicated through station 201-2 to access point 103-2.

The handoff between access points 103-1 and 103-2 occurs in a manner that is transparent to wireless devices 102. Specifically, the transition preferably occurs before the connection to access point 103-1 is lost. Accordingly, there is no interruption in the data communication associated with wireless devices 102. In a similar manner, the transition is transparent to the servers or other resources that are communicating with wireless devices 102.

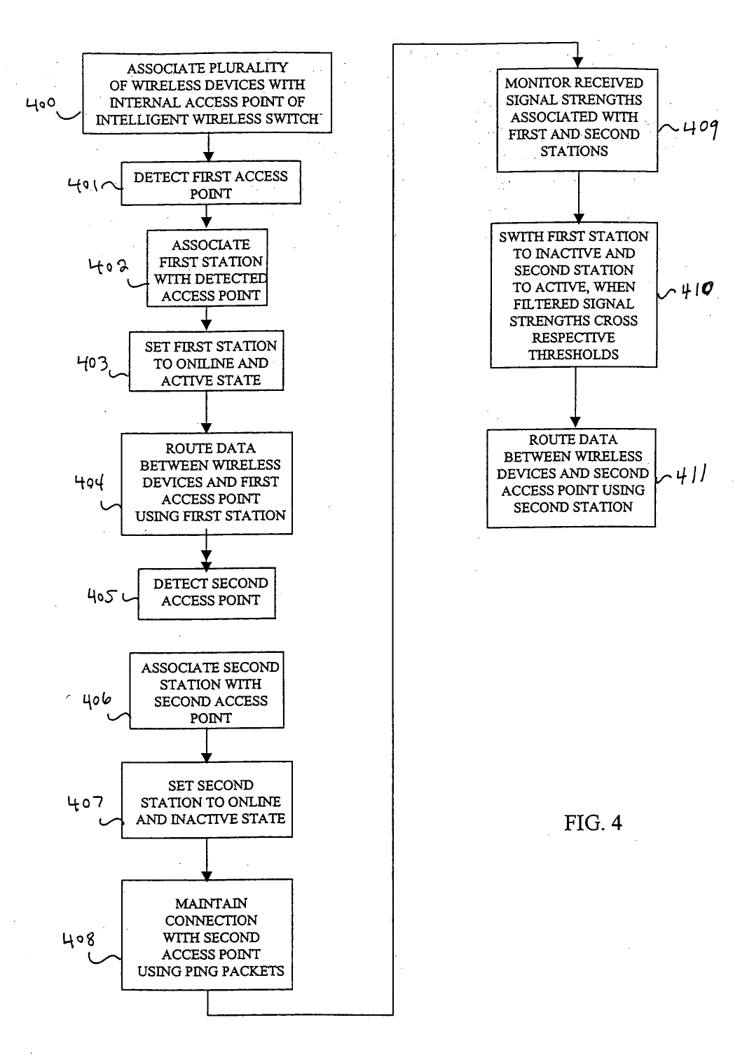

FIG. 4 depicts a flowchart for managing wireless communications for a plurality of wireless devices that are moving in the same direction using an intelligent wireless switch according to one representative embodiment.

In step 400, the plurality of wireless devices are associated with the internal access point of the intelligent wireless switch to enable WLAN communication. In step 401, a first access point is detected. In step 402, a first station of intelligent wireless switch is associated with the first access point. In step 403, the first station is set to an online and active state. In step 404, data is routed between the wireless devices and the first access point using the first station.

In step 405, a second access point is detected. In step 406, a second station of the intelligent wireless switch is associated with the second access point. In step 407, the second station is set to an online and inactive state. In step 408, the connection with the second access point is maintained using ping packets.

In step 409, the received signal strengths associated with the first and second stations are monitored. When the signal strengths cross respective thresholds, the first station is switched to an inactive state and the second station is switched to an active state. In step 411, data is routed between wireless devices and the second access point using the second station.

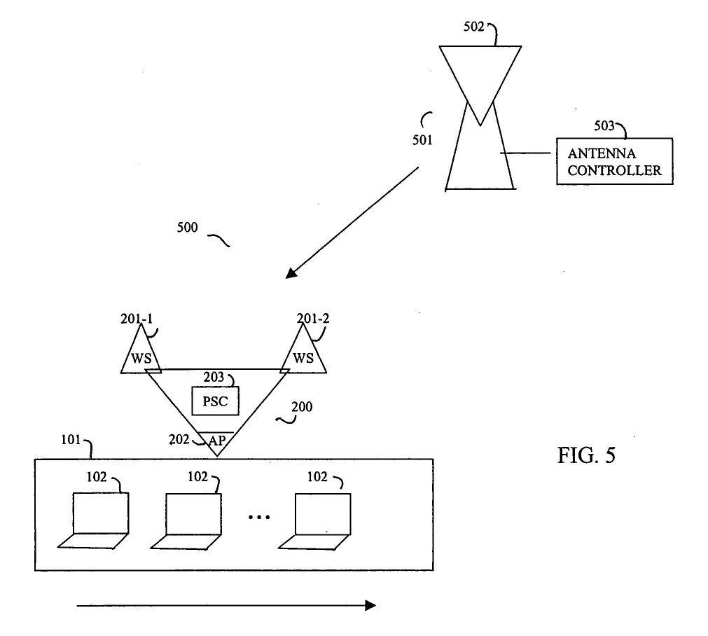

FIG. 5 depicts wireless communications system 500 according to one representative embodiment. Wireless communications system 500 includes train 101 with intelligent wireless switch 200 and wireless devices 102. Wireless communications system 500 further includes base station 501. Base station 501 provides wireless communication hardware to enable wireless communications with intelligent wireless switch 200. Specifically, base station 501 includes directional antenna 502. Directional antenna 502 may include a plurality of discrete antenna elements. The directionality of antenna 502 is achieved by selecting a group of discrete antenna elements associated with the largest antenna gain for communication with intelligent wireless switch 200.

Antenna controller 503 selects the group of antenna elements to be used for communications by monitoring the received signal strength associated with different patterns of antenna elements. As signal strengths cross thresholds, antenna controller 503 switches between patterns of antenna elements. Antenna controller 503 may be implemented using integrated circuit functionality and/or a processor executing suitable software instructions. By switching between antenna elements, base station 501 tracks the movement of train 101 and enables communications to be maintained over a greater distance. Accordingly, a fewer number of base stations 501 can be used to provide coverage over a relatively large area than required by known base station configurations.

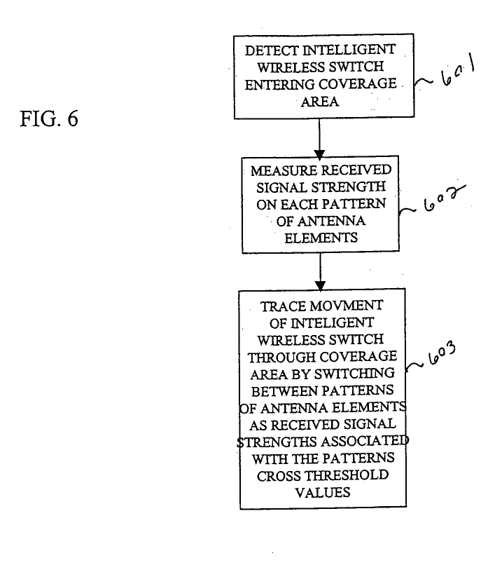

FIG. 6 depicts a flowchart for operating a base station communicating with a moving intelligent wireless switch according to one representative embodiment. In step 601, the intelligent wireless switch is detected entering the coverage area of the base station. In step 602, the signal strength received on each pattern of antenna elements of the base station is measured. In step 603, the movement of the intelligent wireless switch through the coverage area is tracked by the base station by switching between antenna element patterns. The switching between patterns occurs as the received signal strengths cross threshold values.

FIGS. 2 through 6 have discussed a number of embodiments of the invention. It shall be appreciated that the present invention is not limited thereto. A number of changes, variations, and substitutions can be made. For example, in an alternative embodiment, a directional antenna and suitable controller could be implemented within intelligent wireless switch 203. The switching of antenna elements at the intelligent wireless switch may occur in substantially the same manner as the switching at the base station. In another alternative embodiment, the plurality of wireless stations of the intelligent wireless switch may implement a plurality of wireless communication protocols (such as the 802.11 protocol, the 802.16 protocol, the GPRS procotol, and/or like). The switching by the intelligent wireless switch may also occur in response to the availability of coverage for a particular wireless communications protocol in a manner that is transparent to the wireless devices. The internal access point and the stations of the intelligent wireless switch may also use different wireless communication protocols. Moreover, embodiments can be used for any type of transportation vehicle. However, embodiments of the invention are not limited thereto. For example, an intelligent wireless switch could be used in a stationary environment where fading occurs on channels associated with various access points.

By using an intelligent wireless switch, representative embodiments enable wireless communications to occur in an efficient manner. A plurality of wireless devices are able to continuously conduct data communications without interruptions associated with reaching the limits of a coverage area of an external access point. The switching between external access points may occur in a manner that is transparent to users of the wireless devices. Additionally, the number of base stations employed to communicate with the intelligent wireless switch is reduced by using a suitable controller to select antenna element patterns of a direction antenna to track the movement of the wireless switch.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of managing communications associated with a plurality of wireless devices, comprising:
detecting a first access point;
associating a station of a wireless switch with said first access point;
routing data between said plurality of wireless devices and said first access point using said first station;
detecting a second access point;
associating a second station of said wireless switch with said second access point;
monitoring signal strengths of said first and second access points as received by said first and second stations; and
switching to routing data between said plurality of wireless devices and said second access point using said second station in response to said monitoring.

2. The method of claim 1 further comprising:
associating said plurality of wireless devices with an access point of a wireless switch.

3. The method of claim 1 wherein said monitoring comprises:
applying a filtering function to received signal strengths.

4. The method of claim 1 further comprising:
maintaining a connection with said second access point by communicating ping packets through said second access point.

5. The method of claim 1 wherein said plurality of wireless devices and said wireless switch are moving in a common direction, the method further comprising:
operating a base station associated with said first access point by tracking movement of said plurality of wireless devices and said wireless switch using a directional antenna.

6. The method of claim 5 further comprising:
monitoring received signal strengths associated with respective patterns of antenna elements of said directional antenna; and
switching between said patterns in response to monitoring received signal strengths associated with the respective patterns.

7. The method of claim 1 wherein said switching comprises:
receiving packets from the first access point that are associated with transmission control protocol (TCP) sessions; and
sending acknowledgement packets in response to said receiving using said second station.

8. The method of claim 1 wherein said wireless switch is disposed within a transportation vehicle.

9. A wireless switch system for managing communications of a plurality of wireless devices, comprising:
an internal access point for managing a wireless local area network (WLAN) that includes said plurality of wireless devices;
a plurality of stations for communicating with external access points; and
a packet switch controller for routing data between said plurality of wireless devices and external access points using said plurality of stations, wherein said packet switch controller is operable to switch communications between said plurality of stations in response to signal strengths received from said plurality of access points crossing threshold values.

10. The wireless switch system of claim 9 wherein said packet switch controller maintains a connection with one of said plurality of access points by communicating ping packets through said one of said plurality of access points while data packets are communicated through another of said plurality of access points.

11. The wireless switch system of claim 9 wherein said packet switch controller applies a filtering function to received signal strengths.

12. The wireless switch system of claim 9 wherein when said packet switch controller switches communications between a first station to a second station, said switch controller distributes remaining packets received by said first station to said plurality of wireless devices and send acknowledgement packets through said second station.

13. A wireless system, comprising:
a plurality of access points; and
a wireless switch comprising:
a plurality of stations for communicating with said plurality of access points;
an internal access point for managing communication with a plurality of wireless devices; and
a packet switch controller for directing data between said plurality of stations and said plurality of wireless devices, wherein said packet switch controller switches between said plurality of stations in response to signal strengths received from said plurality of access points.

14. The wireless system of claim 13 wherein one of said plurality of access points comprises a base station with a directional antenna, said base station comprising a controller that tracks movement of said wireless switch using said directional antenna through a coverage area of said one of said plurality of access points.

15. The wireless system of claim 14 wherein said controller of said base station monitors signal strengths received from said wireless switch by a plurality of patterns of discrete antenna elements of said directional antenna.

16. The wireless system of claim 15 wherein said controller of said base station switches between said plurality of patterns in response to said monitoring.

17. The wireless system of claim 13 wherein said packet switch controller maintains a connection with one of said plurality of access points that is not currently used for data communications by routing ping packets through said one of said plurality of access points.

18. The wireless system of claim 13 wherein said wireless switch is mounted to a transportation vehicle.
